(19) United States
(12) Patent Application Publication
(10) Pub. No.: US 2023/0345518 A1
(43) Pub. Date: Oct. 26, 2023

(54) OPTIONS FOR INDICATING RECEPTION QUASI CO-LOCATION (QCL) INFORMATION

(71) Applicant: QUALCOMM Incorporated, San Diego, CA (US)

(72) Inventors: Qian ZHANG, Basking Ridge, NJ (US); Yan ZHOU, San Diego, CA (US); Tao LUO, San Diego, CA (US)

(21) Appl. No.: 17/660,049

(22) Filed: Apr. 21, 2022

(51) Int. Cl. H04W 72/08; H04W 24/10; H04W 72/04

(52) U.S. Cl. CPC H04W 72/082; H04W 24/10; H04W 72/042; H04W 72/046

(57) ABSTRACT

Certain aspects of the present disclosure provide techniques for wireless communication by a first user equipment (UE), comprising receiving, from a network entity, a configuration of one or more measurement resources for measuring cross link interference (CLI) between the first UE and a second UE, determining reception quasi co-location (QCL) information of a transmission configuration indicator (TCI) state for the measurement resources, measuring CLI on the measurement resources using the reception QCL information, and reporting the CLI to the network entity.

### BACKGROUND

### Field of the Disclosure

Aspects of the present disclosure relate to wireless communications, and more particularly, to techniques for indicating measured cross-link interference (CLI) based on quasi co-location (QCL) information.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a first user equipment (UE), comprising receiving, from a network entity, a configuration of one or more measurement resources for measuring cross link interference (CLI) between the first UE and a second UE. The method further comprises determining reception quasi co-location (QCL) information of a transmission configuration indicator (TCI) state for the measurement resources. The method further comprises measuring CLI on the measurement resources using the reception QCL information. The method further comprises reporting the CLI to the network entity.

One aspect provides a method for wireless communication by a network entity, comprising transmitting a configuration of one or more measurement resources for measuring CLI between a first UE and a second UE. The method further includes indicating reception QCL information of a TCI state for the measurement resources. The method further includes receiving a report of CLI measured on the measurement resources using the reception QCL information.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIGS. 5A, 5B, and 5C illustrates different full-duplex use cases within a wireless communication network.

FIG. 6A, FIG. 6B, FIG. 6C, and FIG. 6D depict different interference scenarios occurring during full duplex (FD) communications.

FIG. 7 depicts a cross link interference (CLI) scenario for two user equipments during FD communication.

FIG. 8 depicts a call flow diagram for indicating reception QCL information, in accordance with aspects of the present disclosure.

FIG. 9 depicts a method for wireless communications.

FIG. 10 depicts a method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for indicating quasi co-location (QCL) information.

The techniques may help mitigate CLI, for example, when a receiving user equipment (UE) and a transmitting UE communicate in a full duplex (FD) mode of communication. During FD communications, uplink (UL) and downlink (DL) transmissions may be performed simultaneously. For example, in some cases, one UE may transmit information to a network entity, while another UE receives information from the same network entity. In this example, the transmitting UE and the receiving UE may transmit and receive on different beams.

A transmit beam used at a transmitting UE and receive beam used at a receiving UE is collectively referred to as a beam pair. Transmissions between certain beam pairs may interfere with one another, causing UE-to-UE interference which is one example of cross-link interference (CLI). Greater CLI may lead to signal failure and retransmissions, resulting in latency, a waste of resources, and increased power consumption. Receive beam selection is typically left to the UE. Unfortunately, because the base station (e.g., gNB) does not know the CLI for different receive beams, the base station may select a transmit beam that results in significant CLI for a receive beam selected by the UE.

Accordingly, aspects of the present disclosure provide techniques that may help in determining beam pairs with reduced CLI (relative to other beam pairs), which may help with interference mitigation. In some cases, such techniques for interference mitigation may involve indicating beam information, for example, in the form of spatial QCL information. Such information may help select a beam pair with low CLI. For example, a receiving UE may select a receive beam that, in conjunction with the transmit beam of the transmitting UE, results in a beam pair with reduced CLI. In some cases, a receiving UE may select a receive beam based on QCL information in the form of a reception TCI state associated with that beam. The measured CLI associated with a given beam pair may be reported to a gNB for further CLI mitigation.

Accordingly, aspects of the present disclosure may help select beam pairs with reduced CLI. As a result, receive beam communication between a network entity (e.g., a gNB) and UEs may be at least somewhat protected against UE-to-UE interference, which may help reduce latency, resource waste, and power consumption.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

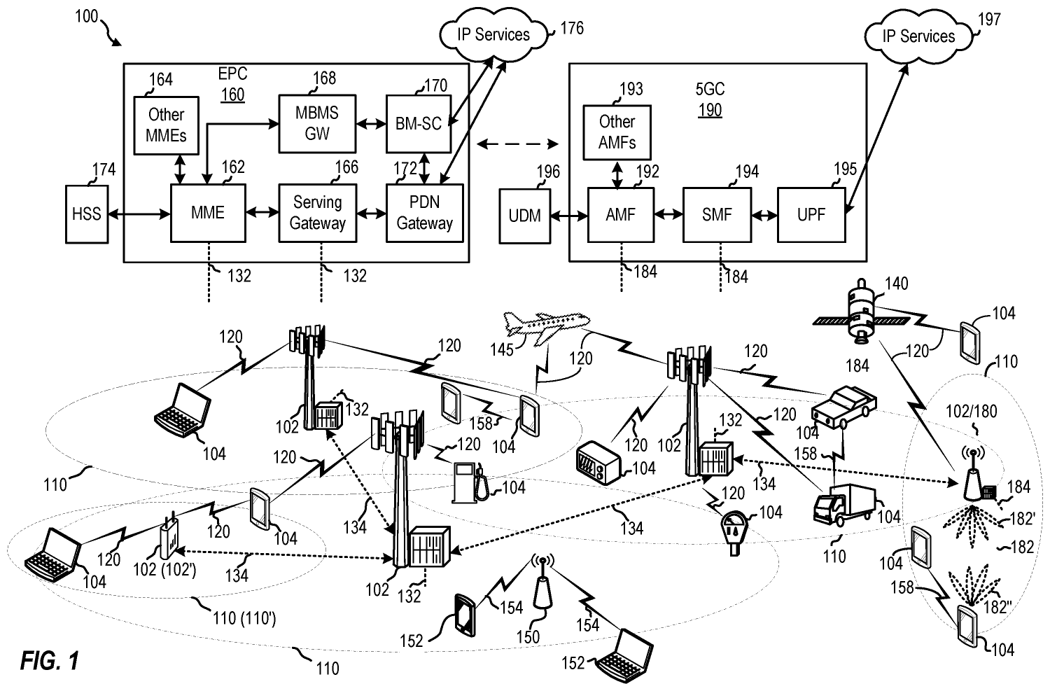

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

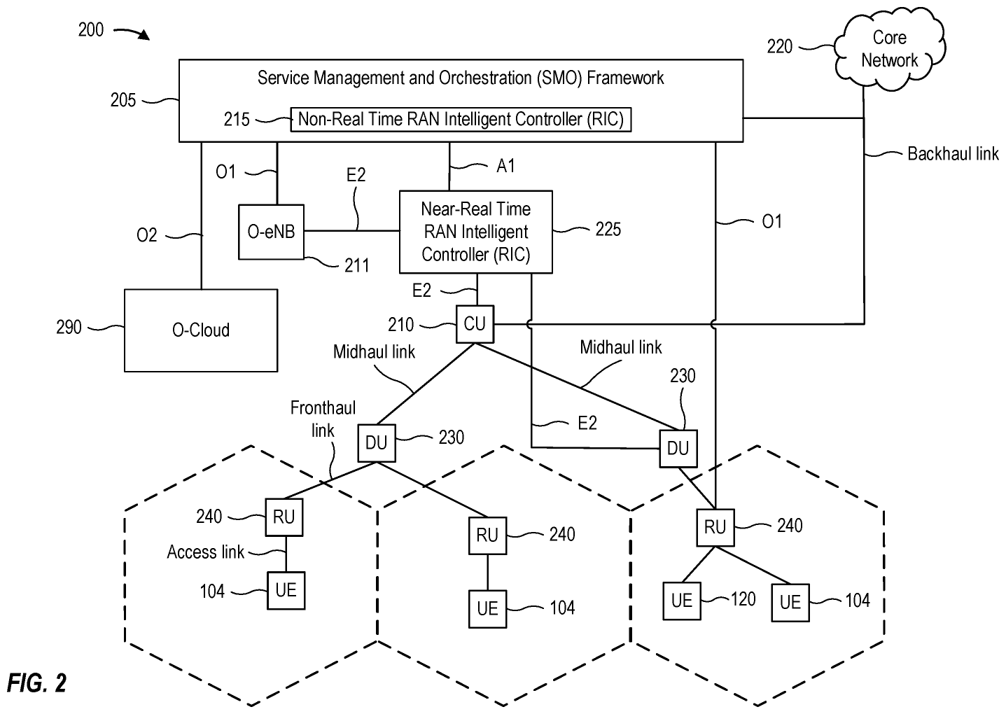

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. BS 180 may also receive the beamformed signal from UE 104 in one or more receive directions 182′. Base station 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (MC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT MC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

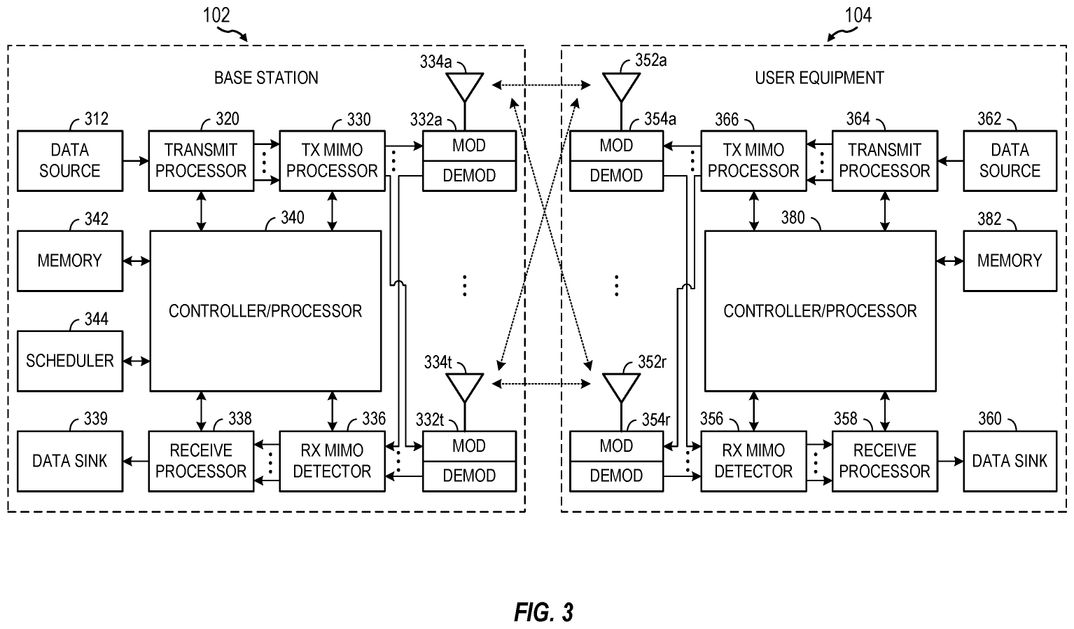

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

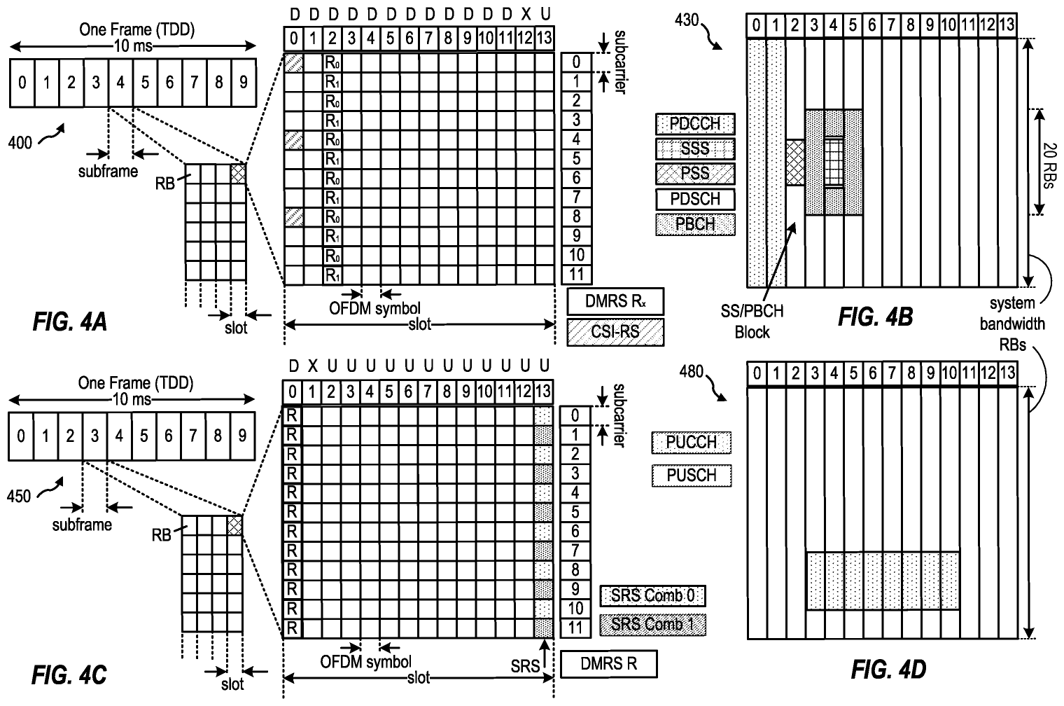

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Full Duplex Use Cases

Aspects of the present disclosure relate to wireless communications, and more particularly, to techniques for indicating, to a network entity, cross-link interference (CLI) measured by a wireless device based on quasi co-location information during full duplex (FD) communications.

As noted above, in some cases, wireless communication devices, such as UEs and BSs, may communicate using multiple antenna panels. In some cases, the multiple antenna panels may be used for half-duplex (HD) communication, such as in current 5G new radio (NR) communication systems, in which downlink (DL) and uplink (UL) transmissions are transmitted non-simultaneously (e.g., transmitted in different time resources). HD communication may be considered baseline behavior in Release 15 (R-15) and 16 (R-16) of 5G NR. In other cases, the use of multiple antenna panels may allow for full duplex (FD) communication whereby uplink (UL) and downlink (DL) transmissions may be performed simultaneously (e.g., in the same time resources). For example, in some cases, UL transmission by the UE may be performed on one panel while DL reception may be performed simultaneously on another panel of the UE. Likewise, at a BS, DL transmission by the BS may be performed on one antenna panel while UL reception may be performed on another antenna panel.

FD capability may be conditioned on beam separation (e.g., frequency separation or spatial separation) and may still be subject to certain self-interference between UL and DL (e.g., UL transmission directly interferes with DL reception) as well as clutter echo (e.g., where UL transmission echoes affect UL transmission and/or DL reception). However, while FD capability may be subject to certain interference, FD capability provides for reduced transmission and reception latency (e.g., it may be possible to receive DL transmissions in an UL-only slot), increased spectrum efficiency (e.g., per cell and/or per UE), and more efficient resource utilization.

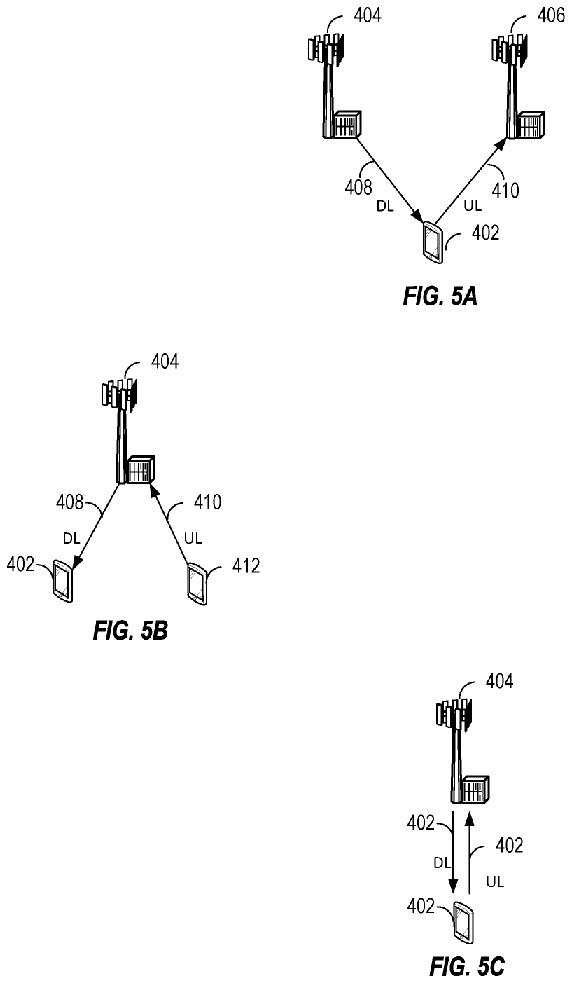

FIGS. 5A-5C illustrates different FD use cases within a wireless communication network, such as the wireless communication network 100. For example, FIG. 5A illustrates a first FD use case involving transmission between one UE 502 and two base stations (or multiple transmission reception points (mTRP)), BS 504 and BS 506. In some cases, UE 502 may be representative of UE 104 of FIG. 1 and BSs 504, 506 may be representative of BS 102 of FIG. 1. As shown, the UE 502 may simultaneously receive DL transmissions 508 from the BS 504 and transmit UL transmissions 510 to the BS 506. In some cases, the DL transmissions 508 and UL transmissions 510 may be performed using different antenna panels to facilitate the simultaneous transmission and reception.

A second FD use case is illustrated in FIG. 5B involving two different UEs and one BS. As illustrated, the UE 502 may receive DL transmissions 508 from the BS 504 while another UE 512 may simultaneously transmit UL transmission 510 to the BS 504. Thus, in this example, BS 504 is conducting simultaneous uplink and downlink communications.

A third FD use case is illustrated in FIG. 5C involving one BS and one UE. As illustrated, the UE 502 may receive DL transmissions 508 from the BS 504 and may simultaneously transmit UL transmissions 510 to the BS 504. As noted above, such simultaneous reception/transmission by the UE 502 may be facilitated by different antenna panels.

Table 1, below, illustrates various example scenarios in which each of the FD use cases may be used.

TABLE 1

| Base Station | UE | FD use case |
|---|---|---|
| FD disabled | FD disabled | Baseline R-15/16 5G |
| | | behavior |
| FD disabled | FD enabled | Use case #1 (FIG. 5A) for |
| | | mTRP |
| FD enabled | FD disabled | Use case #2 (FIG. 5B) + |
| | | R-16 IAB |
| FD enabled | FD enabled | Use case #3 (FIG. 5C) |

As shown in Table 1, if FD capability is disabled at both the base station and UE, the baseline R-15 and R-16 5G behavior may be used (e.g., HD communication). If FD capability is disabled at the BS but enabled at the UE, the UE may operate according to the first example FD use case shown in FIG. 5A in which the UE may communicate with two different TRPs simultaneously (e.g., simultaneous UL and DL transmissions) using two different antenna panels. If FD is enabled at the BS but disabled at the UE (e.g., the UE is not capable of FD), the BS may operate according to the second example FD use case shown in FIG. 5B in which the BS may communicate with two different UEs simultaneously (e.g., simultaneous UL and DL transmissions) using two different antenna panels. Finally, if FD is enabled at both the BS and the UE, the BS and UE may operate according to the third example FD use case shown in FIG. 5C in which the BS and UE may communicate with each other simultaneously on the UL and DL, each of the BS and UE using different antenna panels for UL and DL transmissions.

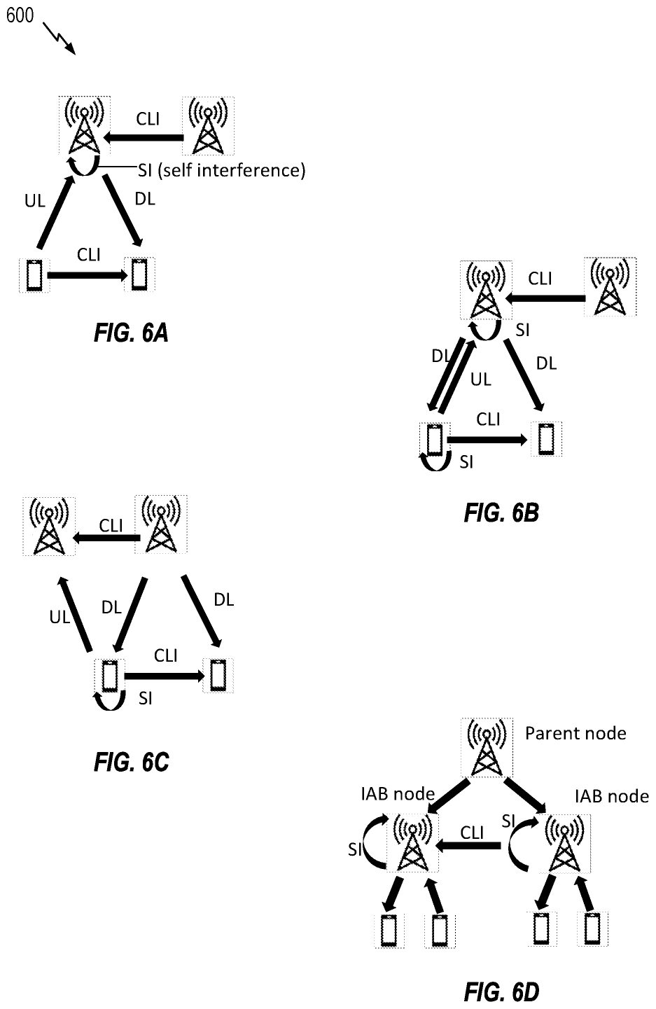

FIG. 6A, FIG. 6B, FIG. 6C, and FIG. 6D illustrate example CLI scenarios for various FD communication use cases.

As illustrated in FIG. 6A, a first CLI scenario may occur when FD is enabled for a gNB but disabled for each connected UE (which in turn may be enabled for half-duplex (HD) communication). The gNB may communicate using FD capabilities according to Use Case 2 of FIG. 5B. In this case, interference may include CLI between UEs, SI from the FD gNB, and CLI between the gNB and neighboring gNBs.

As illustrated in FIG. 6B, a second CLI scenario may occur when FD is enabled for both a gNB and an FD UE/customer premise equipment (CPE) connected to the gNB. The gNB may communicate with the FD UE using FD capabilities according to Use Case 3 of FIG. 5C. If the gNB is connected to a HD UE alongside the FD UE, the gNB communicates with the HD UE according to Use Case 2 of FIG. 5B. In this case, interference may include CLI between UEs, SI from the gNB and the FD UE, and CLI between the FD gNB and neighboring gNBs.

As illustrated in FIG. 6C, a third CLI scenario may occur when FD is disabled for two gNBs (e.g., in a multiple TRP scenario) and enabled at one UE/CPE connected to the two gNBs. The two gNBs may communicate with the FD UE using FD capabilities according to Use Case 1 of FIG. 5A. If one of the two gNBs is connected to a HD UE alongside the FD UE, the one gNB communicates with both the HD UE and the FD UE. In this case, interference may include CLI between UEs, SI from the FD UE, and CLI between the two gNBs.

As illustrated in FIG. 6D, a fourth CLI scenario may occur when two FD IAB nodes have conditional enhanced duplexing capability. In the illustrated example, each of the two IAB nodes are connected to a parent node. Each IAB node may be enabled for FD communication and may communicate with at least two UEs according to Use Case 2 of FIG. 5B. In some cases, nodes involved in the FD use case depicted in FIG. 6D may support same frequency full duplex (SFFD) and frequency division multiplexing (FDM)/spatial division multiplexing (SDM) with resource block group (RBG) granularity. In this case, interference may include CLI between IAB nodes and SI from each IAB node.

As noted above, FD communication may be facilitated through the use of FDM or SDM. In FDM, the simultaneous UL and DL transmissions may be transmitted in the same time resources, but on separate frequency bands separated by some guard band. In SDM, the simultaneous UL and DL transmissions may transmitted on the same time and frequency resources but spatially separated into different, directional transmission beams. Such FD communication contrasts with HD communication that uses time division multiplexing (TDM), in order to schedule UL and DL transmissions on the same or different frequency resources, but at different times.

### Aspects Related to Indicating Measured CLI Based on QCL Information

Aspects of the present disclosure provide techniques for indicating quasi co-location (QCL) information. The various techniques presented herein may allow for inter-UE interference management and could help optimize FD and TDD communication sessions.

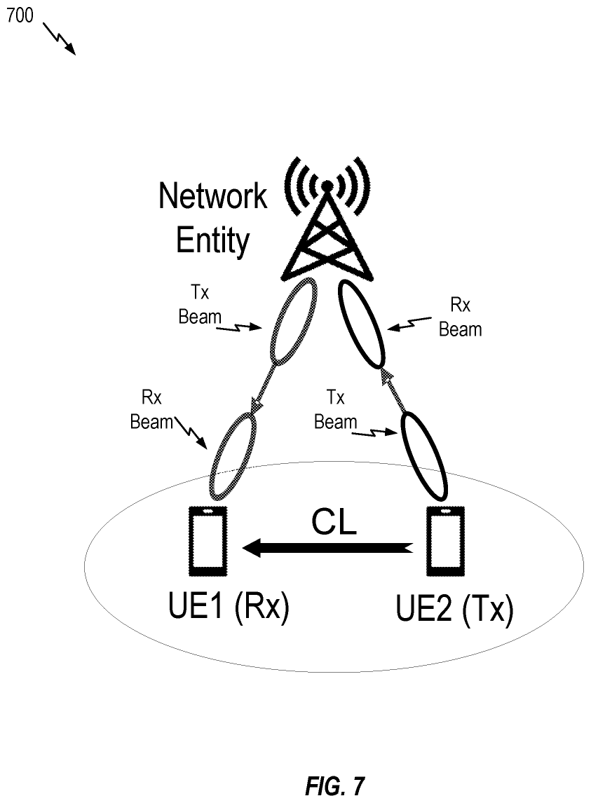

The techniques may help mitigate CLI in various FD scenarios, such as the example deployment 700 illustrated in FIG. 7. For example, the techniques may help reduce or avoid CLI when a first UE (receiving UE1) is receiving downlink transmissions at the same time a second UE (transmitting UE2) is transmitting on the uplink, by conveying information regarding receive beams for CLI measurement. The UEs may report CLI for different UE receive beams, allowing better transmit and receive beam pair selection

In the typical scenario illustrated in FIG. 7, UE1 and UE2 receive no configuration information from the cell network entity (e.g., the gNB) beyond the configured transmission beam. The beam used for reception is typically up to UE implementation. If UE2 is transmitting, for example, a sounding reference signal (SRS) for CLI using a certain transmit beam, it may be beneficial for UE1 to know which receive beam to use. Each potential beam pair combination composed of the transmitting and one of the available receive beams may have different associated CLI. To mitigate interference, UE1 may select a receiver beam that, in conjunction with the transmission beam of UE2, minimizes CLI for the beam pair. According to aspects of the present disclosure, UE1 may select a receive beam based on the reception TCI state of the beam. The measured CLI for a given receive beam, may be reported to the gNB for CLI mitigation.

In current wireless systems (e.g., 5G NR), a CLI framework may have certain limitations that present challenges with regard to optimizing CLI control and reporting for a UE-to-UE beam pair link in various scenarios, such as that illustrated in FIG. 7.

One potential limitation is that a CLI metric for every measurement resource may be configured for reporting. The CLI metric may be configured periodically or it may be configured in response to a triggering action or event during wireless communication. The CLI metric may be included as an extension to a layer one (L1) report, in which case the number of measured candidate beams may be large. Reporting every measured candidate beam may be unnecessary when a gNB is interested in only a subset of candidate inter-UE beam pair links having small CLI compared to all measured candidate beams. Thus, reporting every measured candidate beam may amount to a waste of resources.

Another potential limitation is that higher layer (e.g., layer three L3) filtering may be applied for CLI measurement. Unfortunately, L3 filtering is not suitable for fast L1 beam selection, for example, in response to sudden channel/interference variation. Another potential limitation is that an SRS resource for reference signal received power (RSRP) measurement may have 1 symbol and 1 port. If L1 measurement is extended for a reception beam sweep in this case, there is no guarantee that different SRS resources will be transmitted by a same beam or port.

As noted above, a receiving UE beam for CLI measurement may be determined by UE implementation, either at the receiving UE (UE1 of FIG. 7) or at the transmitting UE (UE2 of FIG. 7). Here, the gNB may not know the CLI for different UE reception beams.

According to certain aspects of the present disclosure, however, UE implemented CLI measurement may utilize reception QCL information of a transmission configuration indicator (TCI) state. In some cases, a first UE may receive, from a network entity (e.g., a gNB), a configuration of one or more measurement resources for measuring CLI between the first UE and a second UE. The first UE may determine reception quasi co-location (QCL) information of a TCI state for the measurement resources (e.g., spatial QCL information indicating a receive beam). The first UE may measure CLI on the measurement resources using the reception QCL information (e.g., Rx beam) and report the CLI to the network entity.

In some cases, a TCI state may be indicated for each measurement resource of a receiving UE (e.g., UE1 of FIG. 7) to measure CLI from one or more neighboring, transmitting UEs (e.g., UE2 of FIG. 7). A receiving UE may report its CLI measurements (for different receive beams) to a gNB where the CLI (per receive beam) would be otherwise unknown to the gNB. This may allow a gNB to take additional action to mitigate interference during FD communications, for example, by indicating certain receive beams via spatial QCL information.

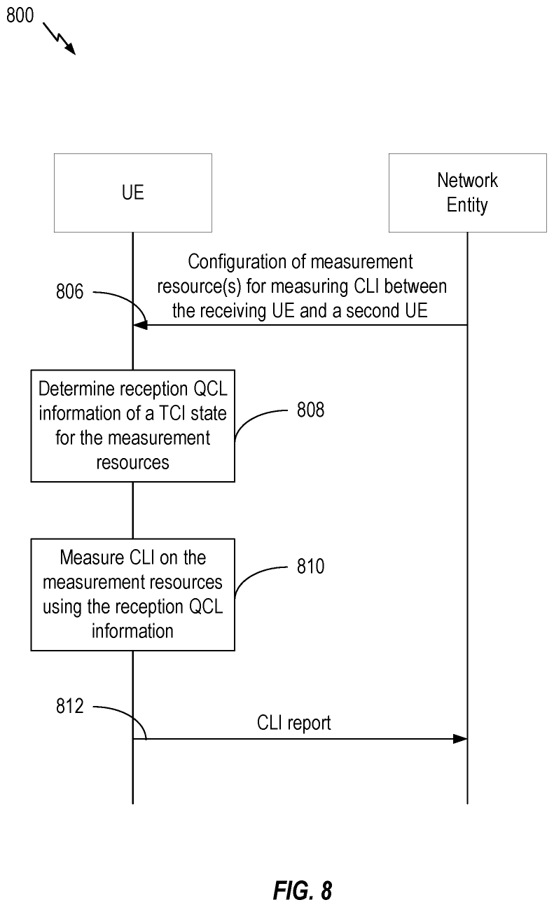

FIG. 8 depicts an example call flow diagram 800 for communications in a network between a base station (BS), a user equipment (UE). In some aspects, the network entity may be an example of the BS 102 depicted and described with respect to FIGS. 1 and 3 (. Similarly, the UE may be an example of UE 104 depicted and described with respect to FIGS. 1 and 3, or UE1 of FIG. 7. In other aspects, UE 104 may be another type of wireless communications device and network entity 102 may be another type of network entity or network node, such as a disaggregate base station unit, such as an RU, CU, or DU described with respect to FIG. 2.

At 806, the network entity transmits a configuration of measurement resource(s) for measuring CLI between the receiving UE and a second UE. At 808, the UE determines reception QCL information of a TCI state for the measurement resources. In certain cases, the TCI state may be indicated per measurement resource, of the one or more measurement resources, for the UE to measure CLI between itself and a neighboring UE.

At 810, a UE measures CLI on the measurement resources using the reception QCL information. At 812, the UE transmits a CLI report to the BS.

In one example, the TCI state for each measurement resource may be configured by a network entity via radio resource control (RRC) signaling (e.g. for a persistent and/or semi-persistent resource). To this end, the measurement resource may be configured in an RRC configuration element (IE) for an SRS (e.g., SRS-ResourceConfigCLI-r16) or a reference signal strength indicator (RSSI) (e.g., RSSI-ResourceConfigCLI-r160), where a reception QCL information field is added in the configuration.

In some cases, a TCI state per measurement resource may be updated via a medium access control (MAC) control element (CE). For example, a TCI state for a semi-persistent resource may be updated via MAC CE.

In some cases, a TCI state per measurement resource may be RRC configured per trigger state. A trigger state may then be indicated via a downlink control information (DCI). For example, a trigger state for an aperiodic resource may be indicated via DCI.

In some cases, a TCI state per resource may be indicated via a DCI. For example, a beam indication DCI for a unified TCI state may be applicable to multiple channels and/or reference signals (RSs). A unified TCI state generally refers to a TCI state that can be indicated among TCI pool pre-configured by a higher layer signaling. Rather than be limited to a particular channel, a unified TCI state may be used for multiple channels/signals simultaneously, which may help reduce singling overhead.

In some cases, a TCI state per measurement resource may be indicated by an implicit rule. In such cases, the rule may indicate that a TCI state is to follow a certain CORESET beam of a receiving UE. The certain CORESET beam may be, for example, the beam having lowest CORESET ID. In another case, the rule may indicate that a TCI state is to follow one activated physical downlink shared channel (PDSCH) TCI state of the receiving UE. The activated PDSCH TCI state may be, for example, the TCI state with the lowest active TCI state ID.

As described herein, aspects of the present disclosure may help select beam pairs with reduced CLI. As a result, communication between a network entity (e.g., a gNB) and UEs may be at least somewhat protected against UE-to-UE interference, which may help reduce latency, resource waste, and power consumption.

### Example Operations of a User Equipment

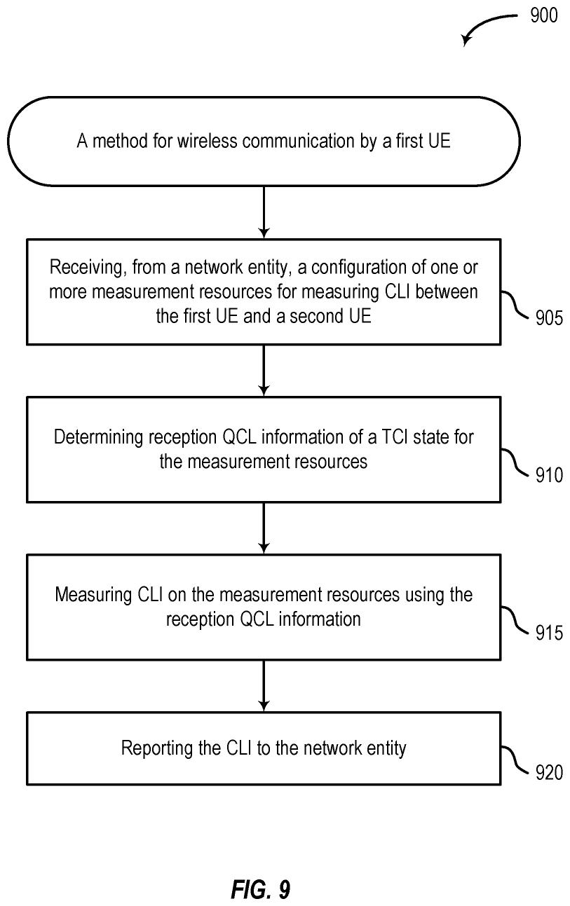

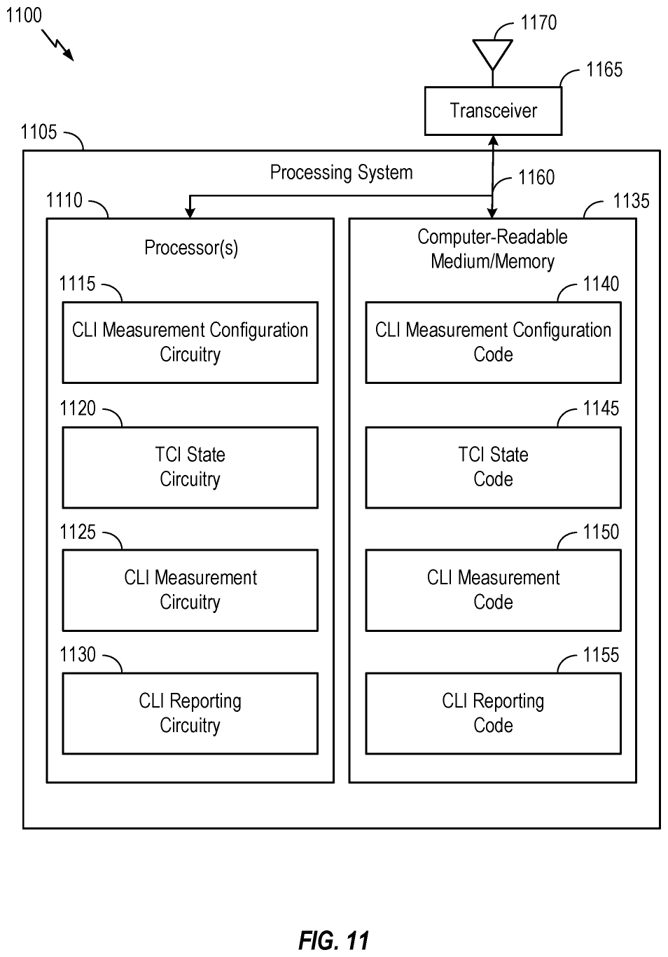

FIG. 9 shows a method 900 for wireless communications by a UE, such as UE 104 of FIGS. 1 and 3. In some aspects, a user equipment, such as UE 104 of FIGS. 1 and 3, or processing system 1105 of FIG. 11, may perform the method 900.

Method 900 begins at 905 with the UE receiving, from a network entity, a configuration of one or more measurement resources for measuring CLI between the first UE and a second UE. In some cases, the operations of this step refer to, or may be performed by, CLI measurement configuration circuitry as described with reference to FIG. 11.

Method 900 then proceeds to step 910 with the UE determining reception QCL information of a TCI state for the measurement resources. In some cases, the operations of this step refer to, or may be performed by, TCI state circuitry as described with reference to FIG. 11.

Method 900 then proceeds to step 915 with the UE measuring CLI on the measurement resources using the reception QCL information. In some cases, the operations of this step refer to, or may be performed by, CLI measurement circuitry as described with reference to FIG. 11.

Method 900 then proceeds to step 920 with reporting the CLI to the network entity. In some cases, the operations of this step refer to, or may be performed by, CLI reporting circuitry as described with reference to FIG. 11.

Various aspects relate to the method 900, including the following aspects.

In some aspects, the TCI state is indicated per measurement resource, of the one or more measurement resources, for the first UE to measure CLI between the first UE and the second UE. In some aspects, the TCI state is indicated per measurement resource via a RRC signaling. In some aspects, the TCI state per measurement resource is determined via at least one of: a SRS resource configuration for CLI, or a RSSI resource configuration for CLI. In some aspects, method 900 further includes receiving a MAC-CE updating the TCI state for at least one of the measurement resources.

In some aspects, the TCI state per measurement resource is RRC configured per trigger state, and indicated via DCI. In some aspects, the TCI state per measurement resource is indicated via DCI. In some aspects, the DCI comprises a beam indication DCI for a unified TCI applicable to at least one of multiple downlink signals or multiple uplink signals. In some aspects, the TCI state per measurement resource is indicated by a rule. In some aspects, the rule indicates the TCI state per measurement resource is based on a TCI state used by the first UE for a CORESET, or an activated PDSCH TCI state of the first UE.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Network Entity

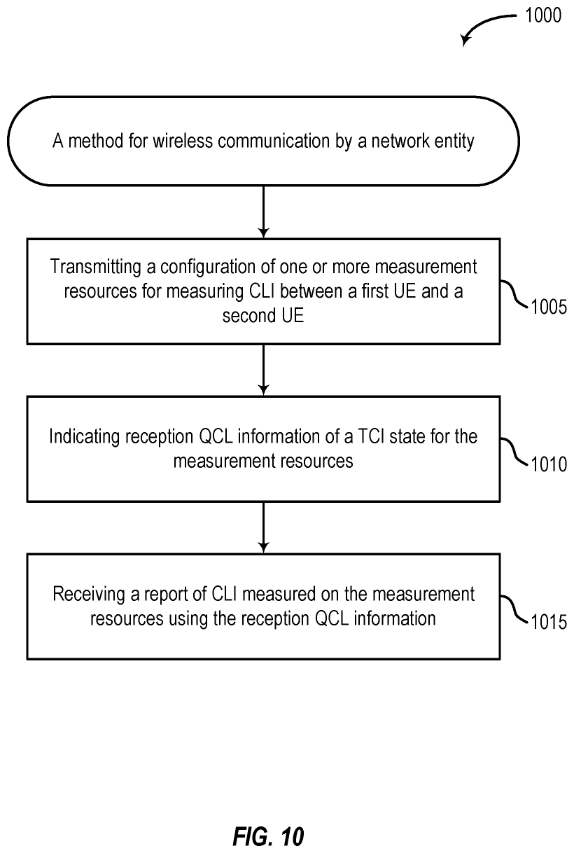

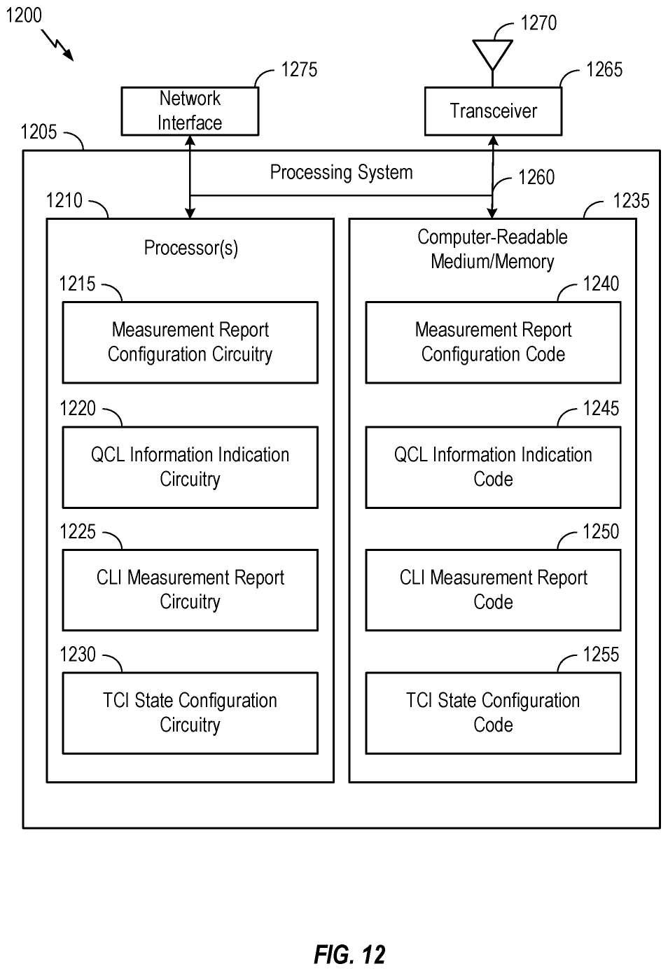

FIG. 10 shows a method 1000 for wireless communications according to aspects of the present disclosure. In some aspects, a base station, such as BS 102 of FIGS. 1 and 3, or processing system 1205 of FIG. 12, may perform the method 1000.

FIG. 10 shows a method 1000 for wireless communications by a network entity, such as BS 102 of FIGS. 1 and 3, or a disaggregated base station as discussed with respect to FIG. 2.

Method 1000 begins at 1005 with a network entity transmitting a configuration of one or more measurement resources for measuring CLI between a first UE and a second UE. In some cases, the operations of this step refer to, or may be performed by, measurement report configuration circuitry as described with reference to FIG. 12.

Method 1000 then proceeds to step 1010 with a network entity indicating reception QCL information of a TCI state for the measurement resources. In some cases, the operations of this step refer to, or may be performed by, QCL information indication circuitry as described with reference to FIG. 12.

Method 1000 then proceeds to step 1015 with a network entity receiving a report of CLI measured on the measurement resources using the reception QCL information. In some cases, the operations of this step refer to, or may be performed by, CLI measurement report circuitry as described with reference to FIG. 12.

Various aspects relate to the method 1000, including the following aspects.

In some aspects, the TCI state is indicated per measurement resource, of the one or more measurement resources, for the first UE to measure CLI between the first UE and the second UE. In some aspects, the TCI state is indicated per measurement resource via a RRC signaling. In some aspects, the TCI state per measurement resource is determined via at least one of a SRS resource configuration for CLI, or a RSSI resource configuration for CLI. In some aspects, method 900 further includes transmitting a MAC-CE updating the TCI state for at least one of the measurement resources.

In some aspects, the TCI state per measurement resource is RRC configured per trigger state, and indicated via DCI. In some aspects, the TCI state per measurement resource is indicated via DCI. In some aspects, the DCI comprises a beam indication DCI for a unified TCI applicable to at least one of multiple downlink signals or multiple uplink signals. In some aspects, the TCI state per measurement resource is indicated by a rule. In some aspects, the rule indicates the TCI state per measurement resource is based on: a TCI state used by the first UE for a CORESET, or an activated PDSCH TCI state of the first UE.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to the transceiver 1165 (e.g., a transmitter and/or a receiver). The transceiver 1165 is configured to transmit and receive signals for the communications device 1100 via the antenna 1170, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1135 via a bus 1160. In certain aspects, the computer-readable medium/memory 1135 is configured to store instructions (e.g., computer-executable code) that when executed by the one or more processors 1110, cause the one or more processors 1110 to perform the method 900 described with respect to FIG. 9, or any aspect related to it. Note that reference to a processor performing a function of communications device 1100 may include one or more processors 1110 performing that function of communications device 1100.

In the depicted example, computer-readable medium/memory 1135 stores code (e.g., executable instructions), such as CLI measurement configuration code 1140, TCI state code 1145, CLI measurement code 1150, and CLI reporting code 1155. Processing of the CLI measurement configuration code 1140, TCI state code 1145, CLI measurement code 1150, and CLI reporting code 1155 may cause the communications device 1100 to perform the method 900 described with respect to FIG. 9, or any aspect related to it.

The one or more processors 1110 include circuitry configured to implement (e.g., execute) the code stored in the computer-readable medium/memory 1135, including circuitry such as CLI measurement configuration circuitry 1115, TCI state circuitry 1120, CLI measurement circuitry 1125, and CLI reporting circuitry 1130. Processing with CLI measurement configuration circuitry 1115, TCI state circuitry 1120, CLI measurement circuitry 1125, and CLI reporting circuitry 1130 may cause the communications device 1100 to perform the method 900 described with respect to FIG. 9, or any aspect related to it.

Various components of the communications device 1100 may provide means for performing the method 900 described with respect to FIG. 9, or any aspect related to it. For example, means for transmitting, sending or outputting for transmission may include transceivers 354 and/or antenna(s) 352 of the UE 104 illustrated in FIG. 3 and/or the transceiver 1165 and the antenna 1170 of the communications device 1100 in FIG. 11. Means for receiving or obtaining may include transceivers 354 and/or antenna(s) 352 of the UE 104 illustrated in FIG. 3 and/or the transceiver 1165 and the antenna 1170 of the communications device 1100 in FIG. 11.

According to some aspects, CLI measurement configuration circuitry 1115 receives, from a network entity, a configuration of one or more measurement resources for measuring CLI between the first UE and a second UE. According to some aspects, TCI state circuitry 1120 determines reception QCL information of a TCI state for the measurement resources. According to some aspects, CLI measurement circuitry 1125 measures CLI on the measurement resources using the reception QCL information. According to some aspects, CLI reporting circuitry 1130 reports the CLI to the network entity.

In some aspects, the TCI state is indicated per measurement resource, of the one or more measurement resources, for the first UE to measure CLI between the first UE and the second UE. In some aspects, the TCI state is indicated per measurement resource via a RRC signaling. In some aspects, the TCI state per measurement resource is determined via at least one of a SRS resource configuration for CLI, or a RSSI resource configuration for CLI.

In some examples, TCI state circuitry 1120 receives a MAC-CE updating the TCI state for at least one of the measurement resources. In some aspects, the TCI state per measurement resource is RRC configured per trigger state, and indicated via DCI. In some aspects, the TCI state per measurement resource is indicated via DCI. In some aspects, the DCI comprises a beam indication DCI for a unified TCI applicable to at least one of multiple downlink signals or multiple uplink signals. In some aspects, the TCI state per measurement resource is indicated by a rule. In some aspects, the rule indicates the TCI state per measurement resource is based on a TCI state used by the first UE for a CORESET, or an activated PDSCH TCI state of the first UE.

FIG. 12 depicts aspects of an example communications device 1200. In some aspects, communications device 1200 is a network entity, such as BS 102 described above with respect to FIGS. 1 and 3.

The communications device 1200 includes a processing system 1205 coupled to the transceiver 1265 (e.g., a transmitter and/or a receiver) and/or a network interface 1275. The transceiver 1265 is configured to transmit and receive signals for the communications device 1200 via the antenna 1270, such as the various signals as described herein. The network interface 1275 is configured to obtain and send signals for the communications device 1200 via communication link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1235 via a bus 1260. In certain aspects, the computer-readable medium/memory 1235 is configured to store instructions (e.g., computer-executable code) that when executed by the one or more processors 1210, cause the one or more processors 1210 to perform the method 1000 described with respect to FIG. 10, or any aspect related to it. Note that reference to a processor of communications device 1200 performing a function may include one or more processors 1210 of communications device 1200 performing that function.

In the depicted example, the computer-readable medium/memory 1235 stores code (e.g., executable instructions), such as measurement report configuration code 1240, QCL information indication code 1245, CLI measurement report code 1250, and TCI state configuration code 1255. Processing of the measurement report configuration code 1240, QCL information indication code 1245, CLI measurement report code 1250, and TCI state configuration code 1255 may cause the communications device 1200 to perform the method 1000 described with respect to FIG. 10, or any aspect related to it.

The one or more processors 1210 include circuitry configured to implement (e.g., execute) the code stored in the computer-readable medium/memory 1235, including circuitry such as measurement report configuration circuitry 1215, QCL information indication circuitry 1220, CLI measurement report circuitry 1225, and TCI state configuration circuitry 1130. Processing with measurement report configuration circuitry 1215, QCL information indication circuitry 1220, CLI measurement report circuitry 1225, and TCI state configuration circuitry 1230 may cause the communications device 1200 to perform the method 1000 as described with respect to FIG. 10, or any aspect related to it.

Various components of the communications device 1200 may provide means for performing the method 1000 as described with respect to FIG. 10, or any aspect related to it. Means for transmitting, sending or outputting for transmission may include transceivers 332 and/or antenna(s) 334 of the BS 102 illustrated in FIG. 3 and/or the transceiver 1265 and the antenna 1270 of the communications device 1200 in FIG. 12. Means for receiving or obtaining may include transceivers 332 and/or antenna(s) 334 of the BS 102 illustrated in FIG. 3 and/or the transceiver 1265 and the antenna 1270 of the communications device 1200 in FIG. 12.

According to some aspects, measurement report configuration circuitry 1215 transmits a configuration of one or more measurement resources for measuring CLI between a first UE and a second UE. According to some aspects, QCL information indication circuitry 1220 indicates reception QCL information of a TCI state for the measurement resources. According to some aspects, CLI measurement report circuitry 1225 receives a report of CLI measured on the measurement resources using the reception QCL information.

In some aspects, the TCI state is indicated per measurement resource, of the one or more measurement resources, for the first UE to measure CLI between the first UE and the second UE. In some aspects, the TCI state is indicated per measurement resource via a RRC signaling. In some aspects, the TCI state per measurement resource is determined via at least one of: a SRS resource configuration for CLI, or a RSSI resource configuration for CLI.

According to some aspects, TCI state configuration circuitry 1230 transmits a MAC-CE updating the TCI state for at least one of the measurement resources. In some aspects, the TCI state per measurement resource is RRC configured per trigger state, and indicated via DCI. In some aspects, the TCI state per measurement resource is indicated via DCI. In some aspects, the DCI comprises a beam indication DCI for a unified TCI applicable to at least one of multiple downlink signals or multiple uplink signals. In some aspects, the TCI state per measurement resource is indicated by a rule. In some aspects, the rule indicates the TCI state per measurement resource is based on a TCI state used by the first UE for a CORESET, or an activated PDSCH TCI state of the first UE.

### Example Clauses

Implementation examples are described in the following numbered clauses:

Clause 1: A method for wireless communications by a first UE, comprising: receiving, from a network entity, a configuration of one or more measurement resources for measuring CLI between the first UE and a second UE; determining reception QCL information of a TCI state for the measurement resources; measuring CLI on the measurement resources using the reception QCL information; and reporting the CLI to the network entity.

Clause 2: The method of Clause 1, wherein the TCI state is indicated per measurement resource, of the one or more measurement resources, for the first UE to measure CLI between the first UE and the second UE.

Clause 3: The method of Clause 2, wherein the TCI state is indicated per measurement resource via a RRC signaling.

Clause 4: The method of Clause 3, wherein the TCI state per measurement resource is determined via at least one of: a SRS resource configuration for CLI; or a RSSI resource configuration for CLI.

Clause 5: The method of any one of Clauses 3 through 4, further comprising: receiving a MAC-CE updating the TCI state for at least one of the measurement resources.

Clause 6: The method of any one of Clauses 2 through 5, wherein the TCI state per measurement resource is: RRC configured per trigger state; and indicated via DCI.

Clause 7: The method of any one of Clauses 2 through 6, wherein the TCI state per measurement resource is indicated via DCI.

Clause 8: The method of Clause 7, wherein the DCI comprises a beam indication DCI for a unified TCI applicable to at least one of: multiple downlink signals or multiple uplink signals.

Clause 9: The method of any one of Clauses 2 through 8, wherein the TCI state per measurement resource is indicated by a rule.

Clause 10: The method of Clause 9, wherein the rule indicates the TCI state per measurement resource is based on: a TCI state used by the first UE for a CORESET; or an activated PDSCH TCI state of the first UE.

Clause 11: A method for wireless communications by a network entity, comprising: transmitting a configuration of one or more measurement resources for measuring CLI between a first UE and a second UE; indicating reception QCL information of a TCI state for the measurement resources; and receiving a report of CLI measured on the measurement resources using the reception QCL information.

Clause 12: The method of Clause 11, wherein the TCI state is indicated per measurement resource, of the one or more measurement resources, for the first UE to measure CLI between the first UE and the second UE.

Clause 13: The method of Clause 12, wherein the TCI state is indicated per measurement resource via a RRC signaling.

Clause 14: The method of Clause 13, wherein the TCI state per measurement resource is determined via at least one of: a SRS resource configuration for CLI; or a RSSI resource configuration for CLI.

Clause 15: The method of any one of Clauses 13 through 14, further comprising: transmitting a MAC-CE updating the TCI state for at least one of the measurement resources.

Clause 16: The method of Clause 12, wherein the TCI state per measurement resource is: RRC configured per trigger state; and indicated via DCI.

Clause 17: The method of any one of Clauses 12 through 16, wherein the TCI state per measurement resource is indicated via DCI.

Clause 18: The method of Clause 17, wherein the DCI comprises a beam indication DCI for a unified TCI applicable to at least one of: multiple downlink signals or multiple uplink signals.

Clause 19: The method of any one of Clauses 12 through 18, wherein the TCI state per measurement resource is indicated by a rule.

Clause 20: The method of Clause 19, wherein the rule indicates the TCI state per measurement resource is based on: a TCI state used by the first UE for a CORESET; or an activated PDSCH TCI state of the first UE.

Clause 21: A processing system, comprising: a memory comprising computer-executable instructions; one or more processors configured to execute the computer-executable instructions and cause the processing system to perform a method in accordance with any one of Clauses 1-20.

Clause 22: A processing system, comprising means for performing a method in accordance with any one of Clauses 1-20.

Clause 23: A non-transitory computer-readable medium comprising computer-executable instructions that, when executed by one or more processors of a processing system, cause the processing system to perform a method in accordance with any one of Clauses 1-20.

Clause 24: A computer program product embodied on a computer-readable storage medium comprising code for performing a method in accordance with any one of Clauses 1-20.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a first user equipment (UE), comprising:
receiving, from a network entity, a configuration of one or more measurement resources for measuring cross link interference (CLI) between the first UE and a second UE;
determining reception quasi co-location (QCL) information of a transmission configuration indicator (TCI) state for the measurement resources;
measuring CLI on the measurement resources using the reception QCL information; and
reporting the CLI to the network entity.

2. The method of claim 1, wherein the TCI state is indicated per measurement resource, of the one or more measurement resources, for the first UE to measure CLI between the first UE and the second UE.

3. The method of claim 2, wherein: the TCI state is indicated per measurement resource via a radio resource control (RRC) signaling.

4. The method of claim 3, wherein the TCI state per measurement resource is determined via at least one of:
a sounding reference signal (SRS) resource configuration for CLI; or
a reference signal strength indicator (RSSI) resource configuration for CLI.

5. The method of claim 3, further comprising receiving a medium access control (MAC) control element (CE) updating the TCI state for at least one of the one or more measurement resources.

6. The method of claim 2, wherein the TCI state per measurement resource is:
radio resource control (RRC) configured per trigger state; and
indicated via downlink control information (DCI).

7. The method of claim 2, wherein the TCI state per measurement resource is indicated via downlink control information (DCI).

8. The method of claim 7, wherein the DCI comprises a beam indication DCI for a unified TCI applicable to at least one of: multiple downlink signals or multiple uplink signals.

9. The method of claim 2, wherein the TCI state per measurement resource is indicated by a rule.

10. The method of claim 9, wherein the rule indicates the TCI state per measurement resource is based on:
a TCI state used by the first UE for a control resource set (CORESET); or
an activated PDSCH TCI state of the first UE.

11. A method for wireless communication by a network entity, comprising:
transmitting a configuration of one or more measurement resources for measuring cross link interference (CLI) between a first user equipment (UE) and a second UE;
indicating reception quasi co-location (QCL) information of a transmission configuration indicator (TCI) state for the measurement resources; and
receiving a report of CLI measured on the measurement resources using the reception QCL information.

12. The method of claim 11, wherein the TCI state is indicated per measurement resource, of the one or more measurement resources, for the first UE to measure CLI between the first ue and the second UE.

13. The method of claim 12, wherein: the TCI state is indicated per measurement resource via a radio resource control (RRC) signaling.

14. The method of claim 13, wherein the TCI state per measurement resource is determined via at least one of:
a sounding reference signal (SRS) resource configuration for CLI; or
a reference signal strength indicator (RSSI) resource configuration for CLI.

15. The method of claim 13, further comprising transmitting a medium access control (MAC) control element (CE) updating the TCI state for at least one of the one or more measurement resources.

16. The method of claim 12, wherein the TCI state per measurement resource is:
radio resource control (RRC) configured per trigger state; and
indicated via downlink control information (DCI).

17. The method of claim 12, wherein the TCI state per measurement resource is indicated via downlink control information (DCI).

18. The method of claim 17, wherein the DCI comprises a beam indication DCI for a unified TCI applicable to at least one of: multiple downlink signals or multiple uplink signals.

19. The method of claim 12, wherein the TCI state per measurement resource is indicated by a rule.

20. The method of claim 19, wherein the rule indicates the TCI state per measurement resource is based on:
a TCI state used by the first UE for a control resource set (CORESET); or
an activated PDSCH TCI state of the first UE.

21. An apparatus for wireless communications at a first user equipment (UE), comprising:
a memory comprising instructions; and
one or more processors configured to execute the instructions and cause the apparatus to:
receive, from a network entity, a configuration of one or more measurement resources for measuring cross link interference (CLI) between the first UE and a second UE;
determine reception quasi co-location (QCL) information of a transmission configuration indicator (TCI) state for the measurement resources;
measure CLI on the measurement resources using the reception QCL information; and
report the CLI to the network entity.

22. An apparatus for wireless communications, comprising:
a memory comprising instructions; and
one or more processors configured to execute the instructions and cause the apparatus to:
transmit a configuration of one or more measurement resources for measuring cross link interference (CLI) between a first user equipment (UE) and a second UE;
indicate reception quasi co-location (QCL) information of a transmission configuration indicator (TCI) state for the measurement resources; and
receive a report of CLI measured on the measurement resources using the reception QCL information.
